(19) United States
(12) Patent Application Publication
(10) Pub. No.: US 2015/0200429 A1
(43) Pub. Date: Jul. 16, 2015

(54) BATTERY MODULE AND HEAT DISSIPATING UNIT THEREOF

(71) Applicant: Simplo Technology Co., Ltd., Hsinchu County (TW)

(72) Inventors: CHAO-FENG LEE, HSINCHU COUNTY (TW); WEN WU, HSINCHU COUNTY (TW); CHIA-HUNG CHIEN, NEW TAIPEI CITY (TW)

(73) Assignee: Simplo Technology Co., Ltd., Hsinchu County (TW)

(21) Appl. No.: 14/244,857

(22) Filed: Apr. 3, 2014

(30) Foreign Application Priority Data
Jan. 13, 2014 (TW) 103101149

(51) Int. Cl. H01M 10/613; F28F 3/12

(52) U.S. Cl. CPC H01M 10/613; F28F 3/12

(57) ABSTRACT

A battery module comprises a base, a set of battery cells and a plurality of heat dissipating units. The base comprises an input opening, an output opening and a plurality of fluid channels. A set of battery cells is disposed on the base and comprises a plurality of battery cells. A channel is formed between neighboring battery cells and the heat dissipating units are respectively disposed in the channels. Each heat dissipating unit has a main body having an expandable fluid channel, a fluid inlet and a fluid outlet. Each expandable fluid channel is communicated with the respective fluid inlet and the respective fluid outlet, and the expandable fluid channels are communicated with the fluid channels of the base. When a coolant flows into the expandable fluid channel, at least one side wall expands with the pressure of the coolant and contacts the surface of the battery cell.

### BACKGROUND OF THE INVENTION

1. Field of the Invention

The present disclosure relates to a battery module and a heat dissipating unit thereof; in particular, to a battery module including a flexible heat dissipating unit.

2. Description of Related Art

In recent years, driven by several factors, usage of batteries have become more and more widespread, and requirements for the batteries have become higher and higher. Safety and stability of operation are important issues for batteries. Of these issues, maintaining a stable temperature for the batteries is very important.

Batteries used in electric vehicles or energy storage systems are typically cylindrically shaped, rectangularly shaped, or soft pack batteries. As known, when batteries are charged or discharged, heat is produced. Controlling the circuit and the components thereof of the battery module also produces heat. When heat inside the battery module cannot be dissipated, long periods of charge or discharge necessarily produce high temperatures in the battery module. When the temperature rises, the casing of the battery module often deforms due to heat, and the high temperature affects the capacity of the battery, reducing the efficacy of the batter or even affecting the functionality of the circuit board and the circuit components thereof, in turn increasing risks of burning or explosion. Therefore, especially in the field of electric vehicles, heat dissipation for battery modules is an especially important issue.

Current common methods of heat dissipation for battery modules include convection by air and convection by fluid. Heat dissipation via convection by air has the advantage of using simpler structures and requires lower cost. The disadvantages of heat dissipation via convection by air are lower rate of dissipation, greater variance in temperature between batteries, and an open design which is vulnerable to foreign particles such as dust. Heat dissipation via convection by fluid has higher rate of dissipation, smaller variance in temperature between batteries, and a sealed design which protects the system against dust particles. The disadvantage of heat dissipation via convection by fluid is that heat dissipation channels need to be designed for cooling fluids, and the heat dissipation channels need to be in close contact with the batteries in order to achieve the effect of heat dissipation.

When using rectangularly shaped or soft pack batteries, the casing of the battering expands due to high temperature. Therefore, design of the heat dissipation channel need to take into account the thermal expansion of the battery, in order for the heat dissipation channel to be in close contact with the battery for effective heat dissipation. In order to solve this problem, current designs use compressible material as a buffer layer between the channel and the batteries. When the batteries expand due to heat, the compressible material of the buffer layer is compressed to adjust the space between the batteries and the channel. The disadvantage of this method is that typical metal are not easily compressible material, and more compressible material are non-metal having lower heat conduction rates than those of metal. Compressible material ensures close contact between the batteries and the channel but have low conduction rate itself, forming a barrier to heat transmission between the battery and the channel.

Hence, the present inventor believes the above mentioned disadvantages can be overcome, and through devoted research combined with application of theory, finally proposes the present disclosure which has a reasonable design and effectively improves upon the above mentioned disadvantages.

### SUMMARY OF THE INVENTION

The object of the present disclosure is to solve the problem of poor contact between a coolant heat dissipating unit and batteries due to thermal expansion of the batteries, which causes poor rate of heat dissipation.

In order to achieve the aforementioned object, the present disclosure provides a heat dissipating unit having a main body. The main body includes at least one expandable fluid channel, at least one fluid inlet and at least one fluid outlet. The expandable fluid channel, the fluid inlet and the fluid outlet are communicated. The main body is adjacent to a heat producing device. When a coolant flows through the fluid inlet into the expandable fluid channel, at least one side wall of the expandable fluid channel is pushed outward by the coolant and expands, tightly contacting the surface of the heat producing body.

In order to achieve the aforementioned object, the present disclosure further provides a battery module having a set of battery cells and a heat dissipating unit. The set of battery cells includes a plurality of arranged battery cells, and any two neighboring battery cells have a channel formed therebetween. The heat dissipating unit has a main body. The main body is bendably disposed in the channels, and includes at least one expandable fluid channel, at least one fluid inlet and at least one fluid outlet. The expandable fluid channel, the fluid inlet and the fluid outlet are communicated. When a coolant flows through the fluid inlet into the expandable fluid channel, at least one side wall of the expandable fluid channel is pushed outward by the coolant and expands, tightly contacting the surface of the surface of the battery cell adjacent to the heat dissipating unit.

In order to achieve the aforementioned object, the present disclosure further provides a battery module having a base, a set of battery cells and a plurality of heat dissipating units. The base includes an input opening, an output opening, and a plurality of fluid channels. The set of battery cells is disposed on the base and includes a plurality of arranged battery cells, and any two neighboring battery cells have a channel formed therebetween. Each of the heat dissipating unit is disposed in the channels. Each of the heat dissipating units has a main body. Each of the main bodies includes an expandable fluid channel, a fluid inlet and a fluid outlet. The expandable fluid channel, the fluid inlet and the fluid outlet of each main body are communicated. The expandable fluid channel and the fluid channels of the base are also communicated. When a coolant flows through the input opening of the base, at least one side wall of each of the expandable fluid channels is pushed outward by the coolant and expands, tightly contacting the surface of the surface of the battery cell adjacent to the heat dissipating units.

The present disclosure has the following advantages:

The heat dissipating unit is flexible so can be bent according to the arrangement of the battery cells, for disposing the heat dissipating unit adjacent to the side walls of the battery cells. Therefore, the present disclosure can be applied in differently arranged battery modules.

The heat dissipating unit has an expandable fluid channel. When a coolant flows into the expandable fluid channel, at least one side wall thereof is pushed by the coolant and expands outward, tightly contacting the surface of a battery cell, thereby effectively transmitting the heat produced by the battery cell outward. The heat dissipating unit can use metal material (e.g. aluminum foil), in addition to the abovementioned characteristic of being in close contact with the battery cell, to achieve the effect of high rate of heat dissipation. High rate of heat dissipation stabilized the output voltage of the battery module, effectively increasing the life span of the battery module.

At least one side wall of the expandable fluid channel of the heat dissipating unit is flexible. So when the casing of the battery cell expands outward due to heat, the side wall of each of the expandable fluid channels maintain a tight contact with the battery cells to achieve the effect of high rate of heat dissipation.

When a coolant or a heating fluid flows into the expandable fluid channel such that at least one side wall of the expandable fluid channel expands outward tightly contacting the battery cell, the expandable fluid channel has the ability to restrict and fix the position of the battery cells. In particular, the battery cells of battery modules applied in electric vehicles are fixed by the side walls of the expanded expandable fluid channels, increasing the resistance to shock of the battery module when the vehicle travelling.

In order to further the understanding regarding the present disclosure, the following embodiments are provided along with illustrations to facilitate the disclosure of the present disclosure.

### BRIEF DESCRIPTION OF THE DRAWINGS

FIG. 1 shows a schematic diagram of a heat dissipating unit according to a first embodiment of the present disclosure;

FIG. 2 shows a cross-sectional view of an expandable fluid channel of a heat dissipating unit according to a first embodiment of the present disclosure;

FIG. 3 shows an expandable fluid channel of a heat dissipating unit according to another embodiment of the present disclosure;

FIG. 4 shows an expandable fluid channel of a heat dissipating unit according to yet another embodiment of the present disclosure;

FIG. 5 shows exploded view of a battery module according to a first embodiment of the present disclosure;

FIG. 6 shows a top view of a heat dissipating unit assembled to a set of battery cells according to a first embodiment of the present disclosure;

FIG. 7 shows a schematic diagram of a unitized heat dissipating unit according to an embodiment of the present disclosure;

FIG. 8 shows a schematic diagram of modular heat dissipating units according to an embodiment of the present disclosure;

FIG. 9 shows a schematic diagram of heat dissipating units according to another embodiment of the present disclosure;

FIG. 10 shows an exploded view of a battery module according to a second embodiment of the present disclosure;

FIG. 11 shows a schematic diagram of a heat dissipation module of a battery module according to a second embodiment of the present disclosure; and

FIG. 12 shows another schematic diagram of a heat dissipation module of a battery module according to a second embodiment of the present disclosure.

### DETAILED DESCRIPTION OF THE PREFERRED EMBODIMENTS

The aforementioned illustrations and following detailed descriptions are exemplary for the purpose of further explaining the scope of the present disclosure. Other objectives and advantages related to the present disclosure will be illustrated in the subsequent descriptions and appended drawings.

### First Embodiment

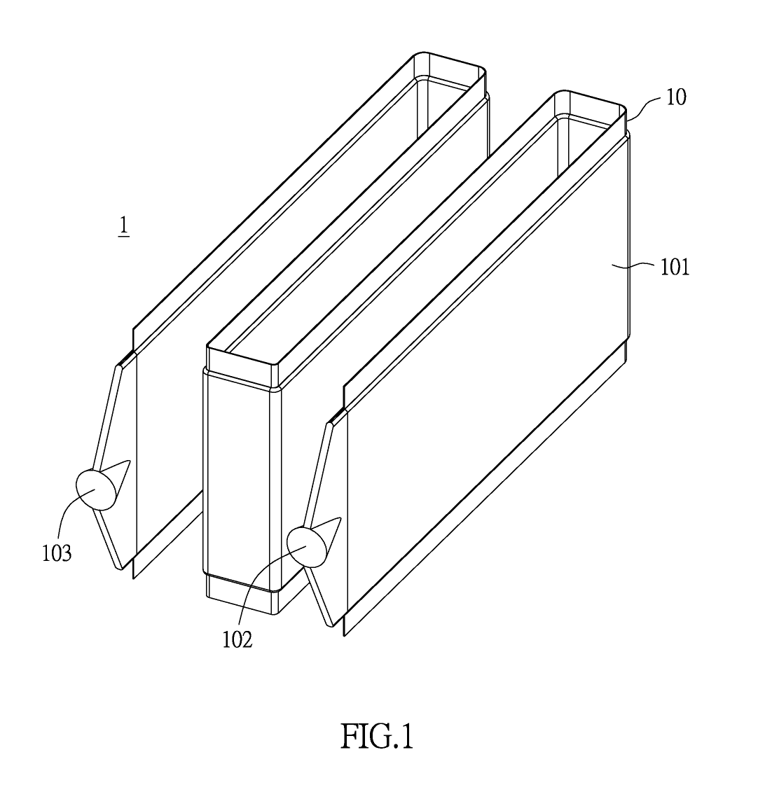

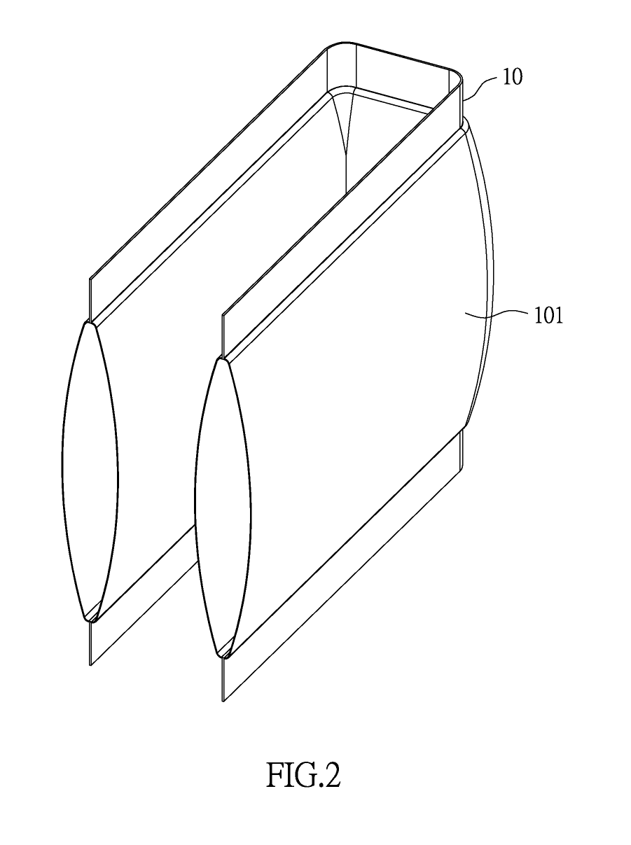

FIG. 1 and FIG. 2 show a heat dissipating unit according to the present disclosure. As shown in the figures, the heat dissipating unit 1 includes a main body 10, which includes an expandable fluid channel 101, a fluid inlet 102 and a fluid outlet 103. The expandable fluid channel 101, the fluid inlet 102 and the fluid outlet 103 are communicated. The main body 10 can be made of a flexible material, and can be bent or wound according to the space created by the arrangement and physical shape of the battery cells. Therefore, the heat dissipating unit 1 can be applied in wide range of types of battery modules, e.g. cylindrically shaped, rectangularly shaped or soft pack batteries. In one embodiment, the main body 10 can be made of an inflexible material, and the shape of the main body 10 is chosen according to the space created by the arrangement and physical shape of the battery cells.

Specifically, in the figures of the present embodiment, the heat dissipating unit 1 is ribbon shaped, and has a single expandable fluid channel 101. The two ends of the expandable fluid channel 101 are respectively formed with the fluid inlet 102 and the fluid outlet 103, and are disposed respectively at the two ends of the ribbon-shaped main body 10. In practice, the present disclosure is not limited thereto. For example, the heat dissipating unit 1 can include a plurality of expandable fluid channels 101, and the fluid inlet 102 and the fluid outlet 103 can be disposed at different locations according to need.

In practice, the heat dissipating unit 1 can be made of metal. For example, the expandable fluid channel 101 can be but is not limited to being made of two sheets of aluminum sealed at the top and bottom, or a single sheet of aluminum folded and sealed.

As shown in FIG. 2, when a coolant enters through the fluid inlet (not shown in the figure) into the expandable fluid channel 101, the two side walls of the expandable fluid channel 101 is pushed by the coolant and expands outward. Thus, when applied to battery cells (not shown in the figure) of a battery module, the two side walls of the expanded expandable fluid channel 101 can tightly contact the side walls of the battery cells, thereby increasing the rate of heat transmission from the battery cells to the coolant. Specifically, given that the two side walls of the expandable fluid channel 101 are made of metal, when the expandable fluid channel 101 tightly contacts the battery cells, heat can be quickly transmitted out. Of particular note, in other applications, the side walls of the expandable fluid channel 101 can be designed according to need to be expandable at only one of the side walls or at both side walls as shown in FIG. 2. In the present embodiment, the heat dissipating unit 1 is ribbon shaped. In practice, the shape of the heat dissipating unit 1 can be modified (as shown in the following embodiments), and is not limited thereto.

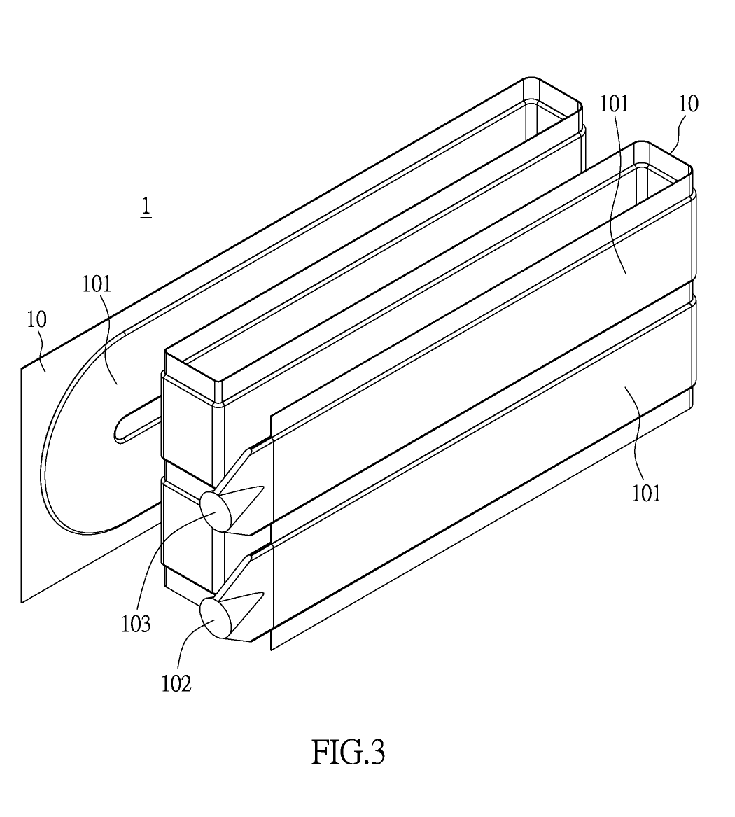

In FIG. 1 and FIG. 2, the fluid inlet 102 and the fluid outlet 103 at two ends of the expandable fluid channel 101 are respectively disposed at two ends of the ribbon-shaped main body 10. As shown in FIG. 3, in another implementation, the expandable fluid channel 10 can include a U-turn, and the fluid inlet 102 and the fluid outlet 103 of thereof can be disposed at the same end of the ribbon-shaped main body 10, simplifying the supply and discharge of coolant.

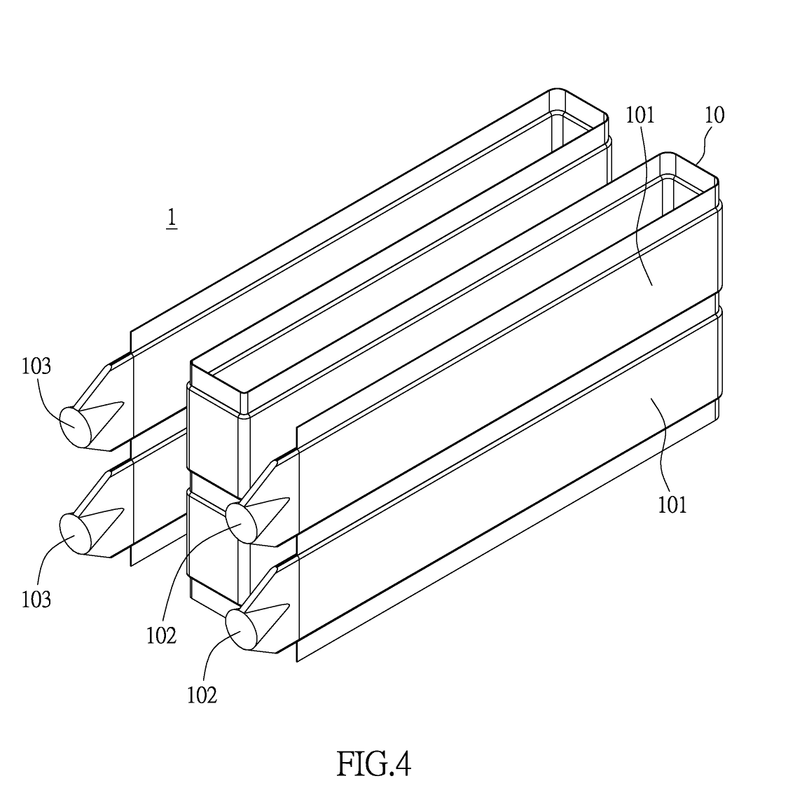

Alternatively as shown in FIG. 4, in another implementation, the heat dissipating unit 1 can have a plurality of expandable fluid channels 101. The figure shows a heat dissipating unit 1 which has two expandable fluid channels 101, and the fluid inlet 102 and the fluid outlet 103 of each of the expandable fluid channels 101 are respectively disposed at two ends of the ribbon-shaped main body 10. Namely, the main body 10 has two separate expandable fluid channels 101 disposed thereon, and the two ends of the main body 10 respectively have two fluid inlets 102 and two fluid outlets 103. The user can determine the temperatures and flow rates of the coolant in the respective expandable fluid channels 101 according to the distribution (e.g. at the top or the bottom of the battery cells) of temperature of the heat producing body, thereby accurately controlling the working temperature of the battery cells and effectively increasing the efficiency of heat dissipation of the heat dissipation unit 1.

### Second Embodiment

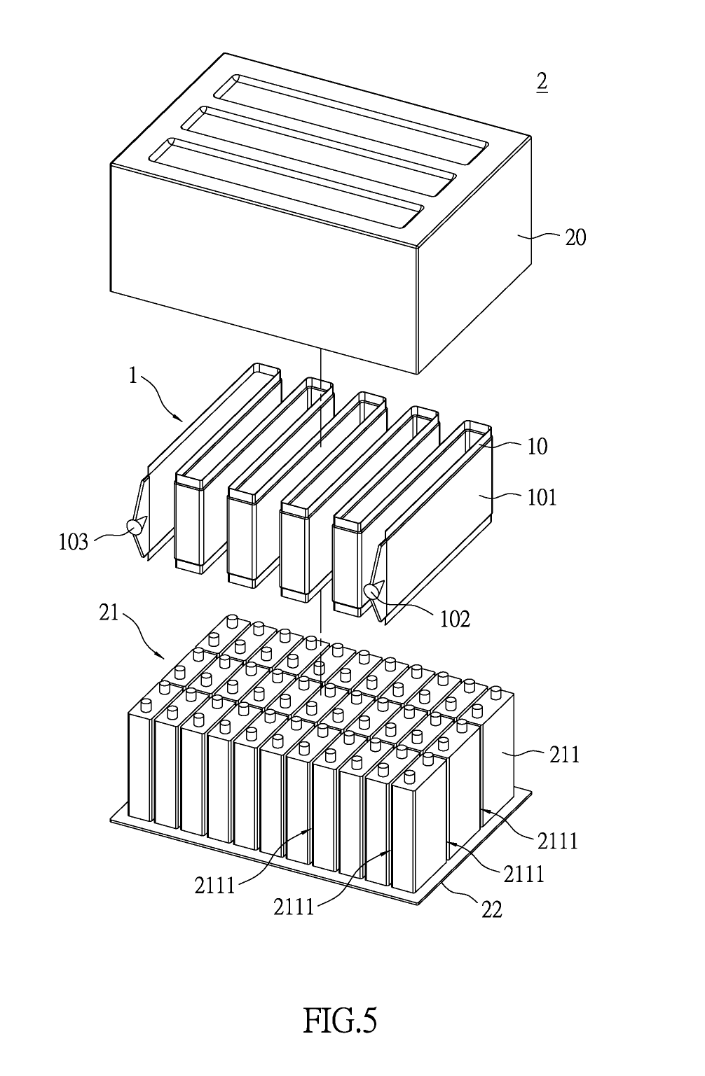

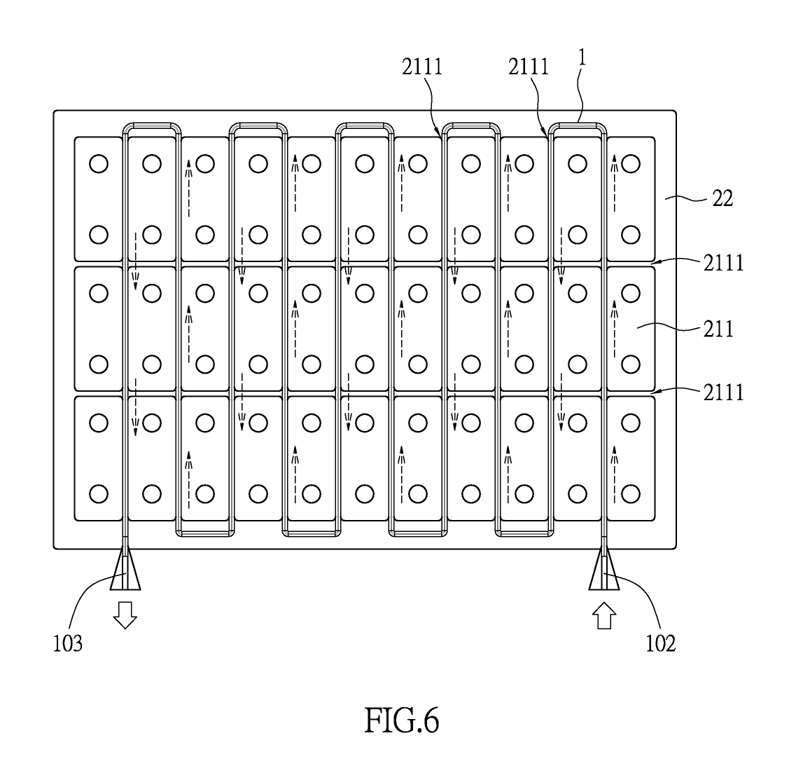

FIG. 5 and FIG. 6 show the aforementioned heat dissipating unit applied to a battery module. As shown in the figures, the battery module 2 includes a top cover 20, a heat dissipating unit 1, a set of battery cells 21 and a base plate 22. The heat dissipating unit 1 includes a main body 10, which includes an expandable fluid channel 101, a fluid inlet 102 and a fluid outlet 103. The expandable fluid channel 101, the fluid inlet 102 and the fluid outlet 103 are communicated. The present embodiment is not limited to what is shown in the figures of the present embodiment, and can implement features of the heat dissipating unit 1 of the previous embodiment, e.g. disposing the fluid inlet 102 and the fluid outlet 103 at any of the two ends of the main body 10, independently disposing a plurality of expandable fluid channels 101 at the heat dissipating unit 1, etc. (in the present embodiment, the fluid inlet 102 and the fluid outlet 103 are respectively disposed at two ends of the main body 10). The set of battery cells 21 is disposed on the base plate 22, and is composed of a plurality of battery cells 211 arranged in a regular pattern. Any two neighboring battery cells 211 have a channel 2111 formed therebetween. The heat dissipating unit 1 is disposed in the channels 2111.

As shown in FIG. 6, the expandable fluid channel 101 of the heat dissipating unit 1 is disposed in the channels 2111 between the battery cells 211 to maximize the area of contact between the expandable fluid channel 101 and the battery cells 211, thereby achieving an ideal effect of heat dissipation. As shown in the figure, the expandable fluid channel 101 is folded to form U-turns so as to be disposed in the channels 2111 between the battery cells 211. In other words, most of the battery cells 211 are each in contact with the expandable fluid channel 101 on two sides to achieve a preferred effect of heat dissipation.

In practice, according to the flow rate of the coolant within the expandable fluid channel 101, the width of the expandable fluid channel 101 can be slightly smaller or equal to the width of the channel 2111 between the battery cells 211. By this configuration, even when the casings of the battery cells 211 expands due to heat during operation, tight contact is still ensured between the expandable fluid channel 101 and the battery cells 211. In other words, when the battery cells 211 expand due to heat during operation, the heat dissipating unit 1 of the present disclosure can still tightly contact the expandable fluid channel 101 and the coolant therein with the battery cells 211, effectively dissipating the heat from the battery cells 211.

In another implementation, if the quantity of battery cells 211 of the set of battery cells 21 is very large, then battery cells 211 at the rear portion of the path of flow of the coolant cannot dissipate heat at the same rate due to increase in temperature of the coolant. In this case, the set of battery cells 21 can be portioned into a plurality of regions, and a heat dissipating unit 1 is disposed in each of the regions, so that the battery cells 21 can dissipate heat at the same or similar rates, which causes the battery cells 21 of the battery module 2 to output the same or similar voltages. The battery module 2 provides stable voltages and the life span of the battery module 2 is increased.

Of particular note, in particular implementations, the base plate 22 of the present embodiment as shown in the figures can be replaced by a base having a fluid channel, and the fluid inlet 102 and the fluid outlet 103 can be communicated with the fluid channel of the base. Through an input opening and an output opening of the base, the coolant flows into the heat dissipating unit 1. The position of the heat dissipating unit 1 in the battery module 2 can be fixed through the base. Additionally, a plurality of fixing structures, e.g. bumps, pivot shafts, snap elements, retaining slots, etc., can be disposed on the base for fixing heat dissipating units 1.

### Third Embodiment

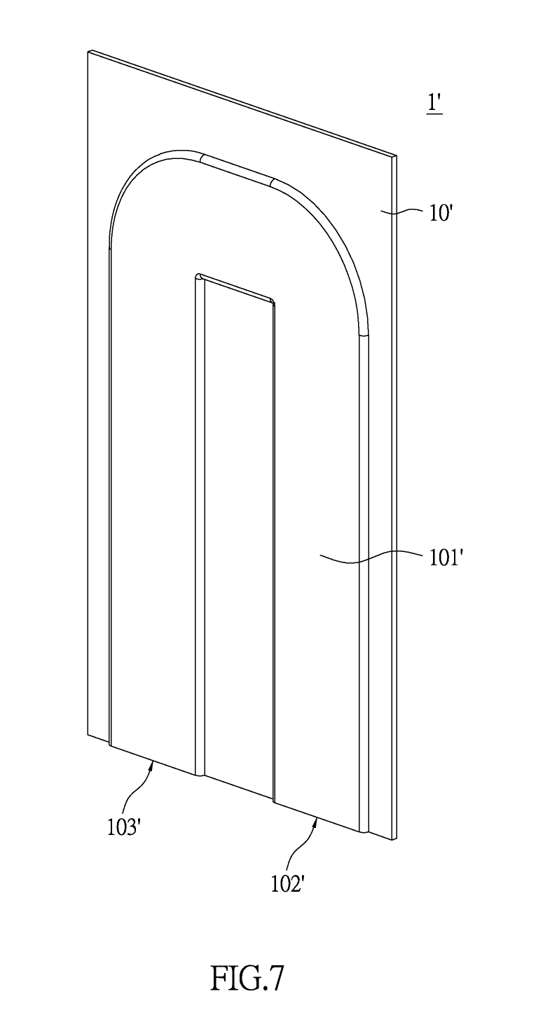

FIG. 7 to FIG. 9 show unitized modular heat dissipating units.

Different from the ribbon-shaped heat dissipating units 1 of the previous embodiments, the heat dissipating unit 1′ of the present embodiment is unitized and modular. As shown in FIG. 7, the main body 10′ of the heat dissipating unit 1′ can be a sheet-shaped unit structure, the expandable fluid channel 101′ can have a U-turn, and the two ends of the expandable fluid channel 101′ are respectively formed with a fluid inlet 102′ and a fluid outlet 103′. In practice, the appearance of the expandable fluid channel 101′ and the width of the same (before and after expansion) can be configured according to practical need (e.g. flow rate of the fluid) and designed accordingly without being limited to what is shown in the figures. Preferably, the expandable fluid channel 101′ is made of metal, e.g. aluminum.

Different from the previous embodiments, the heat dissipating units 1′ can be integrally formed by using flexible material, and disposed between the battery cells. The material of the unitized and sheet-shaped heat dissipating units 1′ of the present embodiment not including the portion of the expandable fluid channel 101′ can be chosen according to need, and can be a flexible or inflexible material. For example, the expandable fluid channel 101′ can be sandwiched between two support plate of greater stiffness to form a unitized heat dissipating unit 1′.

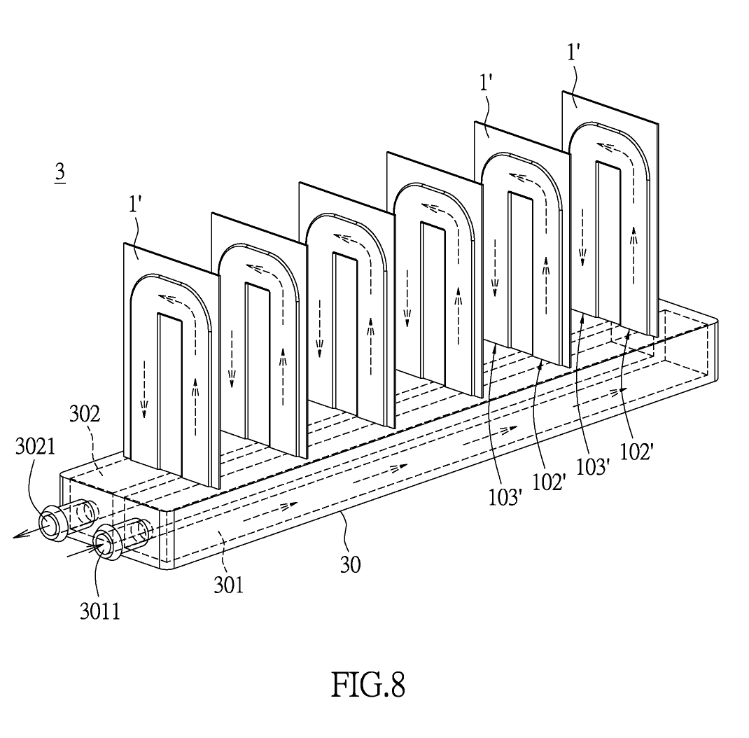

As shown in FIG. 8, heat dissipating units 1′ can be disposed parallelly on a base 30 (the quantity of heat dissipating units 1′ in the figure is that of only one implementation, and the present disclosure is not limited thereto), for forming a heat dissipation module 3. The base 30 can include an input channel 301 and an output channel 302 which are separate from each other. The input channel 301 and the output channel 302 respectively have an input opening 3011 and an output opening 3021. The fluid inlets 102′ and the fluid outlets 103′ of the heat dissipating units 1′ and the input opening 3011 and the output opening 3021 of the base 30 are communicated. The coolant enters the base 30 through the input opening 3011, flows through the input channel 301, separately into the expandable fluid channels 101′ of the respective heat dissipating units 1′, through the output channel 302 and then out of the base 30 through the output opening 3021. By this configuration, the heat accumulated in the coolant after flowing past a heat producing body causes less problem.

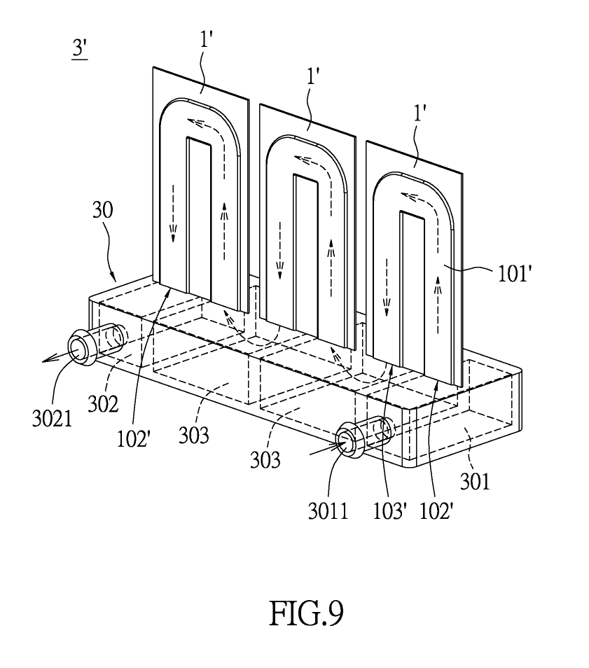

As shown in FIG. 9′, the heat dissipating units 1′ can be disposed serially on a base 30 (the quantity of heat dissipating units 1′ in the figure is that of only one implementation, and the present disclosure is not limited thereto), for forming a heat dissipation module 3′. As shown in the figure, the base 30 can have an input channel 301, an output channel 302 and a plurality of communicating channels 303. The input channel 301 and the output channel 302 respectively have an input opening 3011 and an output opening 3021 formed at one end thereof. The fluid inlet 102′ of one of the heat dissipating units 1′ is connected to the input channel 301 of the base 30 and the fluid outlet 103′ of another of the heat dissipating units 1′ is connected to the output channel 302 of the base 30. The rest of the heat dissipating units 1′ are communicated through the communicating channels 303 of the base 30.

Of particular note, as shown in FIG. 8 and FIG. 9, the input opening 3011 and the output opening 3021 of the base 30 do not have to be arranged on the same side, and can be arranged on opposite sides or any sides of the base 30 according to need. In practice, heat dissipation modules 3 or heat dissipation modules 3′ can be connected serially or parallelly according to need, or the two can be connected serially but are not limited thereto. Additionally, the distance between neighboring heat dissipating units 1′ and the space for the expandable fluid channels 101′ to expand into and be determined according to the distance between neighboring battery cells and the flow rate of the coolant, and is not limited thereto.

### Fourth Embodiment

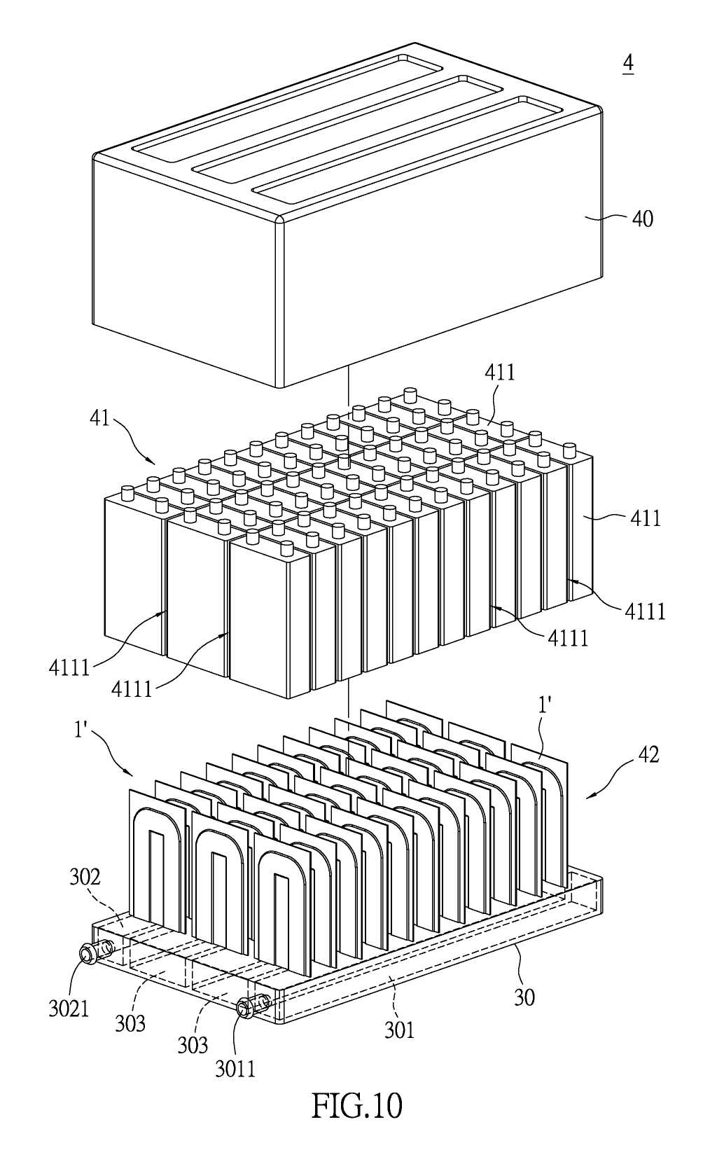

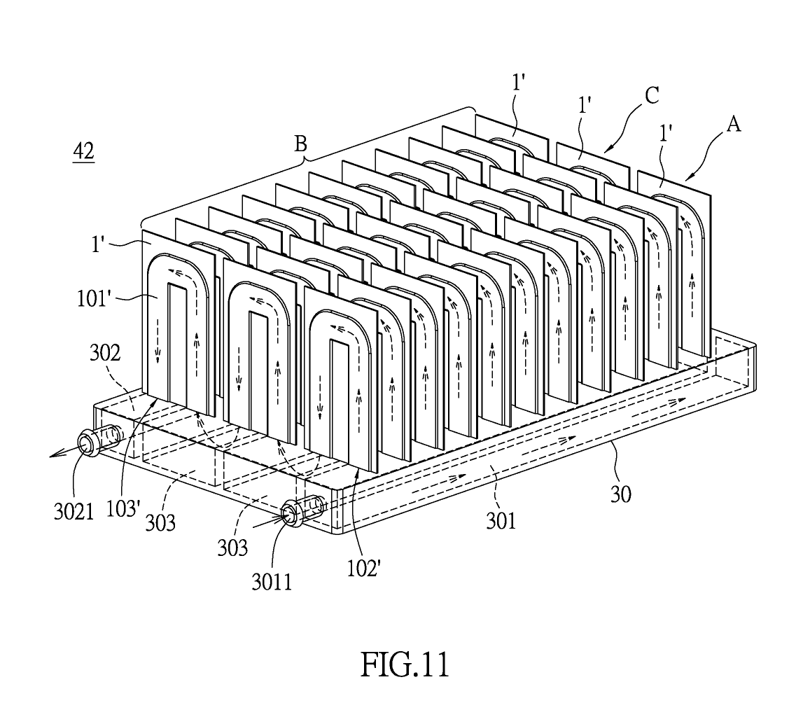

FIG. 10 shows an exploded view of a battery module according to a second embodiment of the present disclosure. FIG. 11 shows a heat dissipation module of the battery module according to the second embodiment of the present disclosure. As shown in FIG. 10, the battery module 4 can include a top cover 40, a set of battery cells 41 and a heat dissipation module 42. The set of battery cells 41 includes battery cells 411 arranged in a pattern. Any two neighboring battery cells 411 have a channel 4111 formed therebetween. The heat dissipation module 42 includes heat dissipation units 1′ arranged in a pattern and a base 30, and each of the heat dissipation units 1′ is communicated with a plurality of fluid channels of the base 30.

Specifically, as shown in FIG. 11, the fluid channels of the base 30 can include an input channel 301, an output channel 302 and a plurality of communicating channels 303. The input channel 301 and the output channel 302 respectively have an input opening 3011 and an output opening 3021. The heat dissipating units 1′ can be partitioned according to position of arrangement into a first group A, a second group B and at least one intermediary group C. The fluid inlets 102′ of the respective heat dissipating units 1′ of the first group A are each connected to the input channel 301 of the base 30. The fluid outlets 103′ of the respective heat dissipating units 1′ of the second group B are each connected to the output channel 302 of the base 30. The expandable fluid channels 101′ of the respective heat dissipating units 1′ of the intermediary group C can be communicated with the heat dissipating units 1′ of the first group A and the second group B through the communicating channels 303 of the base 30.

When the coolant flows through the input opening 3011 of the base 30, the coolant can enter the expandable fluid channels 101′ of the respective heat dissipating units 1′ of the first group A through the input channel 301, such that side walls of the expandable fluid channels 101′ are pushed outward by the coolant and expand, tightly contacting the surface of the battery cells 411. After flowing past the first group A, the coolant flows into the heat dissipating units 1′ of the intermediary group C through the communicating channels 303 of the base 30, and then into the expandable fluid channels 101′ of the heat dissipating units 1′ of the second group B through another communicating channel 303 of the base 30. Finally, the coolant flows through the output channel 302 and out from the output opening 3021 of the base 30. Of particular note, in practice, the distances between neighboring battery cells 411 and the distances between neighboring heat dissipating units 1′ can be adjusted such that the coolant flows into the expandable fluid channels 101′ of the respective heat dissipating units 1′ of the same group evenly and almost at the same time, so that the battery cells 411 are subject to similar cooling effects.

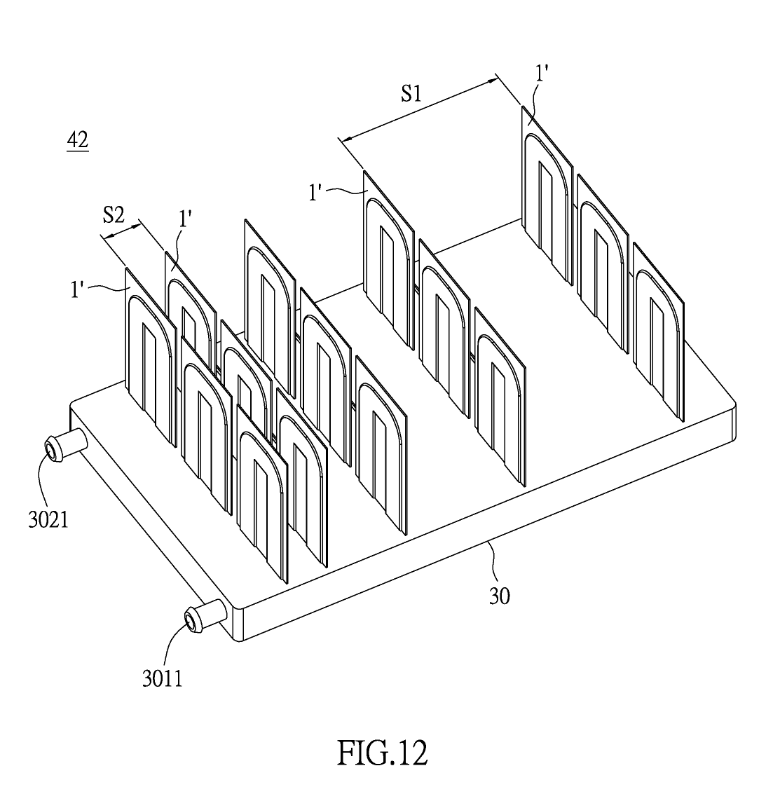

Specifically, as shown in FIG. 12, the distance S1 between two neighboring parallelly connected heat dissipating units 1′ that are further away from the input opening 3011 of the base 30 is greater than the distance S2 between two neighboring parallelly connected heat dissipating units 1′ that are closer to the input opening 3011 of the base 30. (The difference of the distances is exaggerated in the figure; the distances S1, S2 can be determined according to practical situations.) Of course, the expandable space of the expandable fluid channels 101′ of the respective heat dissipating units 1′ need correspond to the distances between neighboring parallelly connected heat dissipating units 1′, such that two side walls of each of the expandable fluid channels 101′ can tightly contact the battery cells. Similarly, the width of each of the channels 4111 of the set of battery cells 41 (the distance between neighboring battery cells 411) can determined according to the distance between neighboring parallelly connected heat dissipating units 1′.

In another implementation, the diameters of the fluid inlets 102′ of the respective heat dissipating units 1′ can be adjusted so that the coolant enters the expandable fluid channels 101′ of the respective heat dissipating units 1′ of each group almost at the same time. For example, heat dissipating units 1′ further from the input opening 3011 of the base 30 can have expandable fluid channels 101′ having greater diameter, and the expandable fluid channels 101′ closer to the input opening 3011 can have smaller diameters. In another particular implementation, the input channel 301 of the base 30 can be slanted. By varying the depth of the fluid channel, the pressure of the fluid changes and the coolant can enter the expandable fluid channels 101′ of the respective heat dissipating units 1′ of the first group A evenly and almost at the same time. Alternatively, the input channel 301 can be tube-shaped having varying diameter for controlling the pressure of the coolant, such that the coolant enters the expandable fluid channels 101′ of the respective heat dissipating units 1′ evenly and almost at the same time.

Of particular note, in practice, the input opening 3011 of the base 30 can be connected to a pump, and the output opening 3021 of the base 30 can be connected to another pump, for pumping the coolant to enter the base 30 at a steady flow rate. Additionally, before the coolant enters the base 30, the pump connected to the output opening 3021 can first draw out air from the expandable fluid channels 101′, such that when the coolant flows into the base 30 the coolant can more easily fill up the expandable fluid channels 101′.

The descriptions illustrated supra set forth simply the preferred embodiments of the present disclosure; however, the characteristics of the present disclosure are by no means restricted thereto. All changes, alternations, or modifications conveniently considered by those skilled in the art are deemed to be encompassed within the scope of the present disclosure delineated by the following claims.

What is claimed is:

1. A heat dissipating unit comprising:
a main body, including at least one expandable fluid channel, at least one fluid inlet and at least one fluid outlet, wherein the expandable fluid channel, the fluid inlet and the fluid outlet are communicated;
wherein, the main body is proximal to a heat producing body, and when a coolant flows into the expandable fluid channel, at least one side wall of the expandable fluid channel is pushed outward by the coolant, expands and tightly contacts the surface of the heat producing body.

2. The heat dissipating unit according to claim 1, wherein the expandable fluid channel is made of metal.

3. The heat dissipating unit according to claim 2, wherein the main body is made of a material selected from the group consisting of a flexible or inflexible material.

4. The heat dissipating unit according to claim 1, wherein the expandable fluid channel is made of aluminum.

5. The heat dissipating unit according to claim 1, wherein main body includes a plurality of expandable fluid channels disposed independently from each other, and two ends of each of the expandable fluid channels are respectively arranged at the fluid inlet and the fluid outlet at two ends of the main body.

6. The heat dissipating unit according to claim 1, wherein the main body includes a plurality of expandable fluid channels disposed independently from each other, a plurality of fluid inlets and one end of each of the expandable fluid channel are arranged at one end of the main body, and a plurality of fluid outlets and another end of each of the expandable fluid channel are arranged at the other end of the main body.

7. The heat dissipating unit according to claim 1, wherein two ends of the expandable fluid channel are formed respectively with the fluid inlet and the fluid outlet, and the fluid inlet and the fluid outlet are arranged respectively at two ends of the main body.

8. The heat dissipating unit according to claim 1, wherein two ends of the expandable fluid channel are formed respectively with the fluid inlet and the fluid outlet, and the fluid inlet and the fluid outlet are arranged respectively at one end of the main body.

9. A battery module, comprising:
a set of battery cells, including a plurality of battery cells arranged in a pattern wherein any two neighboring battery cells have a channel formed therebetween; and
a heat dissipating unit, including a main body bendably disposed in the channels, wherein the main body includes at least one expandable fluid channel, at least one fluid inlet and at least one fluid outlet, and the expandable fluid channel, the fluid inlet and the fluid outlet are communicated;
wherein, when a coolant flows into the expandable fluid channel, at least one side wall of the expandable fluid channel is pushed outward by the coolant, expands and tightly contacts the surface of the battery cells.

10. The battery module according to claim 9, wherein the expandable fluid channel is made of metal.

11. The battery module according to claim 9, wherein the expandable fluid channel is made of aluminum.

12. The battery module according to claim 9, further comprising a base, wherein the base includes an input channel and an output channel, the input channel and the output channel are respectively formed with an input opening and an out opening, and the fluid inlet and the fluid outlet of the heat dissipating unit are respectively communicated with the input opening and the output opening.

13. The battery module according to claim 9, wherein main body includes a plurality of expandable fluid channels disposed independently from each other, and two ends of each of the expandable fluid channels are respectively arranged at the fluid inlet and the fluid outlet at two ends of the main body.

14. The battery module according to claim 9, wherein the main body includes a plurality of expandable fluid channels disposed independently from each other, a plurality of fluid inlets and one end of each of the expandable fluid channel are arranged at one end of the main body, and a plurality of fluid outlets and another end of each of the expandable fluid channel are arranged at the other end of the main body.

15. The battery module according to claim 9, wherein two ends of the expandable fluid channel are formed respectively with the fluid inlet and the fluid outlet, and the fluid inlet and the fluid outlet are arranged respectively at two ends of the main body.

16. The battery module according to claim 9, wherein two ends of the expandable fluid channel are formed respectively with the fluid inlet and the fluid outlet, and the fluid inlet and the fluid outlet are arranged respectively at one end of the main body.

17. A battery module, comprising:
a base having an input opening, an output opening and a plurality of fluid channels;
a set of battery cells, disposed on the base and including a plurality of battery cells arranged in a pattern wherein any two neighboring battery cells have a channel formed therebetween; and
a plurality of heat dissipating units disposed respectively in the channels and each including a main body, wherein the main body includes an expandable fluid channel, a fluid inlet and a fluid outlet, each of the expandable fluid channels is communicated with the respective fluid inlet and the respective fluid outlet, and the expandable fluid channels are communicated with the fluid channels of the base;
wherein, when a coolant flows into the expandable fluid channel, at least one side wall of the expandable fluid channel is pushed outward by the coolant, expands and tightly contacts the surface of the battery cells.

18. The battery module according to claim 17, wherein the expandable fluid channel is made of metal.

19. The battery module according to claim 17, wherein the expandable fluid channel is made of aluminum.

20. The battery module according to claim 17, wherein the widths of the channels more distal from the input opening are greater than the widths of the channels more proximal to the input opening.

21. The battery module according to claim 17, wherein the spaces for expansion for the expandable fluid channels more distal from the input opening are greater than the spaces for expansion for the expandable fluid channels more proximal to the input opening.

22. The battery module according to claim 17, wherein the diameters of the fluid inlets of the heat dissipating units more distal from the input opening are greater than the diameters of the fluid inlets of the heat dissipating units more proximal to the input opening.

23. The battery module according to claim 17, wherein two ends of each of the expandable fluid channels are respectively formed with one of the fluid inlets and one of the fluid outlets, and the fluid inlet and the fluid outlet are disposed at one end of the respective main body.

24. The battery module according to claim 17, wherein the base includes an input channel, a plurality of communicating channels and an output channel, the input channel and the output channel are respectively connected to the input opening and the output opening, the heat dissipating units are partitioned into a first group, at least one intermediary group, and a second group, the fluid inlets of the heat dissipating units of the first group are connected to the input channel, the fluid outlets of the heat dissipating units of the second group are connected to the output channel, and the fluid outlets of the heat dissipating units of the first group, the expandable fluid channels of the heat dissipating units of the intermediary group, and the fluid inlets of the heat dissipating units of the second group are communicated through the communicating channels of the base.
